(19) United States
(12) Patent Application Publication
(10) Pub. No.: US 2023/0070296 A1
(43) Pub. Date: Mar. 9, 2023

(54) BITE FORK DEVICE WITH IMPRESSION MATERIAL PUMPING PROVISION

(71) Applicants: CANER KARACEPER, OTTAWA (CA); CEM KARACEPER, OTTAWA (CA); ANIDA DZAFIC, OTTAWA (CA); PRAKASH CRJ NAIDU, OTTAWA (CA)

(72) Inventors: CEM KARACEPER, OTTAWA (CA); CANER KARACEPER, OTTAWA (CA); PRAKASH CRJ NAIDU, OTTAWA (CA); ANIDA DZAFIC, OTTAWA (CA)

(21) Appl. No.: 17/952,992

(22) Filed: Sep. 26, 2022

(51) Int. Cl. A61C 7/08; B33Y 80/00

(52) U.S. Cl. CPC A61C 7/08; B33Y 80/00

(57) ABSTRACT

A bite fork or bite tray device with channels to facilitate flow of impression material through the substrate while held inside a patient's oral cavity to obtain bite registration or impression consisting of full or partial teeth impression or full or partial gum impression or alveolar bone or alveolar process or alveolar ridge or a combination of these. A process for use of the system for prescription or design or manufacture of an appliance by providing the necessary steps.

### CROSS-REFERENCE TO RELATED APPLICATIONS

Not applicable

### STATEMENT REGARDING FEDERALLY SPONSORED RESEARCH OR DEVELOPMENT

The work on which the disclosure of this application is based is not funded by any Federally Sponsored Research or Development in the United States of America.

### BACKGROUND OF THE INVENTION

### Field of the Invention

The present invention pertains to instruments used for dental assessments or interventions for designing and making of aligners, dentures, and oral appliances or mouth guards for the prevention of snoring, sleep apnea, bruxism or similar other conditions, more particularly to a bite fork or bite tray that can be used for bite registrations to enable bite classification, jaw classification, or bite curvature measurement.

### Description of the Related Art

It is well known and documented that bite fork or bite tray is a useful instrument platform to record the position of maxillary or upper teeth relative to the cranial base. Mechanical and other jaw simulators typically use the information obtained by means of bite forks for design and manufacture of aligners, dentures and other oral or orthodontic appliances. A typical first step towards manufacture of an orthodontic or orthopedic appliance meant for closed bite cases, also known as oral appliances, is obtaining what is commonly known as a “construction bite” or “occlusion” registered using a bite fork (thus also known as bite fork registration or bite registration. As it is crucial to correspond occlusion with the proper alignment of teeth and jaw of a person in relation with the manufactured appliance, a convenient and accurate means to capture bite registration is important to eliminate or minimise potential misalignment.

Some of the information obtained by bite fork's bite registration are well known and established in the art. Broadly, bite registration is useful to estimate or measure a person's jaw class, bite class, or curvature of bite also known as occlusion. One or more of these classifications may be relevant to design and manufacture an appropriate oral appliance.

Bite classification or occlusion generally includes what is called Vertical Dimension of Occlusion (VDO) representing relationship between the upper or maxillary arch and lower or mandibular arch of human dentition. While VDO is the vertical dimension of occlusion, VDR is the Vertical Dimension of Rest, considered when a person or patient is fully relaxed. The difference between VDO and VDR is called “Freeway Space” or interocclusal space. When making a dental appliance, we are making it within these boundaries and the bite fork allows us to properly measure for this range that is why our bite forks also come in different thicknesses ranging from 0.5 millimeters to 10 millimeters suitable for verifying VDO of the person and in addition optionally verifying freeway space suitable for specific appliance being prescribed, designed or manufactured. For example, some appliances such as night guards do not need much “Freeway Space”, in that case we use a thinner bite fork. For other appliances, we may need thicker bite forks. Therefore, bite forks' selection is also based on the appliance being prescribed, designed and manufactured.

Generally, there are five types of bite classification: Class One, Class Two or overbite, Class Two—Division One, Class Two—Division Two, and Class Three or underbite, or other emerging classes. Bite classification is crucial to assess what is known in the art as malocclusion which is an incorrect relation or misalignment between the teeth of the lower or mandibular and upper or maxillary dental arches when they approach each other as the jaws of a person close. While Edward Angle's classification (Angle E. “Classification of malocclusion”. Dental Cosm.1899; 41:248-64) is most popular, there are several subsequent and emerging classifications known in the art.

Jaw classification determines relationship of the alveolar bone with respect to the person's dentition comprising of three types of classes including class one, class two, and class three, or other emerging classes (Graber™. Orthodontics Principles and Practice. 3rd ed., Philadelphia: W.B. Saunders; 1972. p. 155-6; Unger J W. Comparison of vertical morphologic measurements on dentulous and edentulous patients: J Prosthet. Dent. 1990, August; 64(2): 232-4).

Curvature of bite or occlusion comprises of three types of curves including Curve of Wilson, or Curve of Spee, or Curve of Monson, or other emerging curves (Kagaya K, Minami I, Nakamura T, Sato M, Ueno T, Igarashi Y. “Three-dimensional analysis of occlusal curvature in healthy Japanese young adults”. J Oral Rehabil 2009; 36:257-63; Ferrario V F, Sforza C, Miani A Jr. “Statistical evaluation of Monson's sphere in healthy permanent dentitions in man”. Arch Oral Biol 1997; 42:365-9; Patil P. “100 Years for Curve of Monson and Still Relevant”, International Journal of Prosthodontics and Restorative Dentistry. 2022; 11(3), 110).

Generally, a bite fork is of approximately horse-shoe shape to tally with the shape of a human dental arch, is smeared or loaded with semi-solid impression material externally and placed into a person's oral cavity between the maxillary and mandibular teeth. Subsequently, the person is asked to bite down on the bite fork enabling forming of a mold of the impression material capturing an impression of the person's teeth.

Some bite forks have been disclosed that include features for improvements in terms of convenience of use, stability, ability to scan teeth while taking the bite registration, and other such inventive steps.

Adell describes in U.S. Pat. No. 5,346,395 dated Sep. 13, 1994 titled “Dental Arch Bite Registration Device” a device that consists of multi-laminar structure fabricated from ethylene vinyl acetate using injection molding process to bond one lamina to another without the use of any adhesive wherein the different lamina have different durometer properties.

Jacobs and Jacobs describe in U.S. Pat. No. 5,562,449 dated Oct. 8, 1996 titled “Custom Dental Tray” a dual dental tray assembly which includes a pliable resilient outer dental tray using a pre-formed thin inner tray of thermoplastic material that nests inside the pliable outer tray. Although Jacobs's disclosure does not directly relate to a bite fork which is the subject of current disclosure, the use of thermoplastic material has common ground as the two trays are heated to between 145°-160° F. resulting in the inner tray becoming more formable, allowing for the inner tray to be accurately formed over the patient's teeth. Subsequent cooling to room temperature makes the tray hard and rigid retaining the acquired shape.

Patent application DE20105234U1 titled “Ready-to-use bite fork for single use in dental technology” published dated 5 Jul. 2001 describes a bite fork having a U-shaped bite section and a holding section along with partial reference pad supports and a torsion-resistant carrier.

Karapetyan describes in U.S. Pat. No. 7,220,123 dated 22 May 2007 titled “Device For Registration of the Dental Bite” a two-piece device for dental bite registration, each generally of a half-U-shaped configuration, coupled with one another forming a full U-shape with provision in the handle to lock them together.

Patent application DE202011105953U1 published dated 20 Oct. 2011 titled “Bite fork and bite-taking set” describes a bite fork with impression material having a bite recording part with a first fastening means, and a position marking part with second fastening means matching the first fastening means, which is detachably connected to the bite recording part.

Patent application DE202015105356U1 published dated 12 Oct. 2016 titled “Bite fork with bars” describes a bite fork with bite surface recesses to enable partial visualization of the tooth surfaces by 3D surface scanner and markers while the bite fork is placed in the oral cavity of a patient. In a substantially similar disclosure, Brunner describes in Patent publication EP2964136B1 dated 10 Mar. 2021 titled “Bite fork with recesses” (a version also published earlier as WO 2014/135160 dated 12 Sep. 2014), a bite fork comprising of a first processing means for correlating the image of the tooth surfaces and the position data of the bite fork to provide a true to space coordinate image of the tooth surfaces, a para-occlusal tray to be attached to the teeth with further position marker elements, a second position detection means adapted to the further position marker elements for the ongoing position detection of the para-occlusal tray during movements of the dentition, and respective processing means.

Kopp describes in U.S. Pat. No. 8,123,521 dated Feb. 28, 2012 titled “Device for the Registration of the position of a protruding mandible” a bite fork type device albeit for a different purpose of registration of a mandibular position that is protruded relative to the normal position, with an U-shaped impression plate having finger like registration surfaces.

Kerschensteiner and Christen describe in U.S. Pat. No. 10,299,898 dated May 28, 2019 titled “Method for preparing a partial or full dental prosthesis” a broad process for preparing dental prosthesis that includes preparation of bite plates or forks along with a review of Angle's bite classifications (Angle classes as described in Lehrbuch der Zahntechnik, Volume 1, A. Hohmann/W. Hielscher, Quintessenzverlag, pp 130/131).

Charkhandeh describes in U.S. Pat. No. 10,751,153 dated Aug. 25, 2020 titled “Apparatus and method for registration of a digital dental bite” yet another configuration of a bite fork for obtaining digital open bite registration including at least one molar pad and at least one incisor pad, each of the pads having respective upper and lower bite surfaces, with further option of inclusion of a band extending between the molar pad and the incisor pad. The application of this is directed mainly towards manufacture of oral appliances for Obstructive Sleep Apnea (OSA) patients.

Ackel describes in U.S. Pat. No. 11,096,764 dated Aug. 24, 2021 titled “Dental Tray Molding Kit and Method for Dental Molding” a method for dental tray molding that includes providing a generic tray, heating a thermoformable member until sufficiently pliable, placing the thermoformable member over the generic tray, placing a deformable spacer member over the thermoformable member, applying a biting force from a user onto the thermoformable member through the deformable spacer member, cooling the thermoformable member and separating the thermoformable member, whereby the thermoformable member forms a custom dental tray. Here the bite fork is provided as a kit component part of the dental tray molding kit.

These and similar other bite forks, however, are all requiring application of impression materials on the surfaces of the bite fork externally and manually, without any more efficient and controlled means to do the same. Manual application by scoop, putty applicator or spoon type devices does not ensure even and just adequate quantity of impression material distribution over the bite surfaces. Furthermore, most of the bite forks currently available do not have the flexibility to comply with the curvature of the bite.

### BRIEF SUMMARY OF THE INVENTION

### Statement of the Object of the Invention

The objective of the invention is to improve the convenience, quality, and accuracy of impression material application on one or more surfaces of the bite fork device. As bite fork is a very common and extensively used device in the field of oral appliances design and manufacture, improvements in the same has significant and considerable impact on the users of the device. A bite fork is used by dental professionals including dentists, orthodontists, prosthodontists, denturists, etc. for prescription of a variety of orthodontic appliances such as aligners, retainers, night guards or mouth guards, sleep apnea treatment oral appliances (e.g. Mandibular Advancement Devices or Stents), anti-snoring devices, dentures, and several others. A bite fork may also be self-administered by a user or patient in a home or clinical setting, likely following written, oral, or other means of instructions from a professional. As examples, let us consider two of the major markets where bite forks are used by dentists and denturists: aligners and dentures.

According to the SEC archives (United States Securities and Exchange Commission, Registration No. 333, Form S-1 filed on Aug. 16, 2019), the major emerging market share holder of aligners, SmileDirectClub® Inc. submitted that the global orthodontics market is estimated as approximately 500 million people, the U.S.A. market leading at approximately 124 million people. It is also postulated in this filing that probably 85% of people worldwide have malocclusion, out of which less than 1% are only treated annually, leaving a huge scope for expansion of this market in future. As bite registration is an important step in design and manufacture of aligners, this is a significant opportunity to improve the functionality and user convenience during registration of a patient's bite. As so-called clear aligners are poised to be emerging as direct-to-consumer (DTC) orthodontics with newer entrants such as SmileDirectClub® Inc. leading the way (Wexler et. al., “Direct-to-Consumer Orthodontics: Surveying the User Experience”, J. Am. Dent. Assoc. 2020 August; 151(8): 625-636.e4; doi: 10.1016/j.adaj.2020.02.025), user experience in terms of ease-of-use features is becoming even more important.

According to several estimates quoting the Journal of Prosthetic Dentistry, 37.9 million Americans were estimated to require dentures in 2020 (Douglass et. al. “Will there be a need for complete dentures in the United States in 2020?”, J. Prosthet Dent. 2002 January; 87(1):5-8. doi: 10.1067/mpr.2002.121203). That's nearly 9% of the United States population. As Canadian population is approximately 0.11 of the USA population (Simon Fraser University. Population Comparison of Canada, United States, and Mexico: Profile Report, World Population), assuming similar North American demographics, the estimated denture users in Canada are 4.17 million, adding up the potential application of the disclosed invention's improvement benefits reaching to about 42 million. The overall bite fork user market is much larger than this, likely about three times of this considering younger populations too needing devices such as aligners, mouth guards, anti-snoring, obstructive sleep apnea treatment devices and several other oral or orthodontic appliances that require bite registration as a preliminary step, as stated earlier. By providing features in the bite forks that makes use of them for bite registration more convenient, faster, using less impression material by even and just adequate amount of application, and enabling flexibility for capturing curvature aspects of the bite registration, we would be providing a pioneering solution not available in the market currently.

Therefore, we can conclude from this brief of the statement of the object of the invention that filling a much desirable gap in the field by providing improved solution to a substantial number of users of bite forks involved in design and manufacture of oral appliances would be of immense benefit.

### Gist of the Invention

The preferred embodiment of disclosed invention provides additional features in a bite fork substrate to facilitate easy connectivity with an impression material source, a means to pump the impression material through channels inside the substrate, enabling effusion of the material from orifices or openings on the substrate where the bite impression is specifically needed. The pumping process can be done after insertion of the substrate inside a patient's oral cavity. This approach enables uniform distribution of the impression material, while minimizing the amount of impression material, by pumping just necessary and adequate quantity of the impression material.

According to one aspect of the invention, the bite fork substrate may be provided with a snap fit, threaded, or a clamping mechanism such as a worm clamp or spring clamp for ease of connectivity and dis-connectivity between the substrate and the impression material source. According to another aspect of the invention, the impression materials source may be integrated with a manual pumping mechanism to pressurize the flow of the material into the bite fork. Additionally, and optionally, the pumping mechanism may be motorized by integration of a miniaturized electric pump. Those skilled in the art may appreciate that there can be several configurations of locations of integration of the pump with the impression materials source and the bite fork substrate, for example, direct pressurization of impression material or indirect pressurization such as through air or hydraulic pressure from a relatively distant location, enabling the bite fork assembly to be light and compact while held inside a person's oral cavity.

Courting to another aspect of the invention, the substrate has internal or external channels to facilitate passage and flow of the impression material from the source to the destination region where the bite registration is realized. Optionally, but preferably, the channels may be internal and cylindrical shaped. Other shapes of channels such as square or rectangular or triangular, or elliptical cross sections may also be deployed as they are realizable conveniently if the substrate is made using additive manufacturing or 3D printing technology which is the preferred mode of manufacturing under this disclosure. However, other modes of manufacturing such as injection molding or milling and drilling or other methods that may be available in the state-of-the-art are also covered under the spirit and scope of the invention, although they may have limitations, for example the channels if formed by drilling may only be cylindrical in shape. made of light weight flexible bio-compatible material such as Nylon-12 or a stretchable bio-compatible elastomer. The substrates may be manufactured by several alternative means such as molding, 3D printing or additive manufacturing, or milling.

The bite fork substrate may be made of light weight flexible bio-compatible material such as Nylon-12 or a stretchable bio-compatible elastomer. Broadly, the substrate may be made of plastic material such as bio-compatible Polyamides, Polyolefins, Polyesters, Fluoropolymers, Elastomers, Poly-p-xylylene, Polystyrenes, Biopolymers, Resins and several other combinations and reinforced hybrid materials. Preferably, but optionally, the bite fork substrate may be made of a bio-compatible thermoplastic such as Polyform, Methacrylate, or Ethylene Vinyl-acetate, such as Elvax 250, manufactured by DuPont®, Wilmington, Del., USA.

Courting to yet another aspect of the invention, optionally, but in addition, the impression material pumped may be formed of multi-layer hybrid construction wherein a stronger (when solidified and hardened) impression material layer forms the core to provide strength and stability of impression areas in contact with teeth or gums over which softer impression material is layered allowing a combination of both strength as well as flexibility. The softer material, if constrained by barrier means surrounding the impression areas, may act as spring to ensure tighter and more compact and thus more accurate bite registration. The multi-layer construction may be achieved by several alternative pumping approaches such as simultaneous pumping of different impression materials from different channels, and sequential pumping of different impression materials from same channels.

According to an additional but optional aspect of the invention, one or more deflectors, valves or other means or combinations of the same are sequentially or concurrently deployed for enabling controlled distribution of ejection of the impression material from the different openings. Optionally, the control of ejection of material is based on feedback from at least one or more sensors.

According to another additional but optional method of use of the invention, bite or occlusion classification of a person to determine malocclusion by recording vertical dimension of occlusion pertaining to upper and lower arch of the person's dentition may be acquired. Additionally, but optionally, jaw classification of a person to determine relationship of the alveolar bone with respect to the person's dentition may be obtained. Furthermore, additionally, but optionally, curvature of bite or occlusion may also be obtained.

In summary, the disclosed invention of a bite fork device with provision for pumping impression materials offers considerable improvement and advantages over those described in prior art in general, as a more convenient to use with just appropriate application of impression material in particular.

### BRIEF DESCRIPTION OF THE DRAWINGS

FIG. 1 shows an overall assembled block diagram view of an embodiment of the invention having a bite fork substrate, a connection to source of one or more constituents of impression material through a mixer unit, the sources of impression material, and a representative amount of impression material pumped over the substrate of the bite fork.

FIG. 2 presents a perspective view of a typical non edge to edge dual arch bite fork substrate.

FIG. 3 shows a plain bottom view of the FIG. 2, without showing the clipping, or breaking lines and retention lines.

FIG. 4 shows a lateral or side view-P of FIG. 3.

FIG. 5 shows a Sectional view at section B-B of FIG. 4 illustrating a typical impression material flow channel configuration of a typical non edge to edge dual arch bite fork substrate.

FIG. 6 shows a slightly perspective view (nearly top view) of a typical edge to edge dual arch bite fork substrate.

FIG. 7 shows a lateral or side view-Q of FIG. 6.

FIG. 8 presents a perspective view of a typical single arch bite fork substrate.

FIG. 9 shows a plain top view of the FIG. 8.

FIG. 10 shows a lateral or side view-R of FIG. 9.

FIG. 11 shows an identical Sectional view at section C-C and Section D-D of FIG. 10 illustrating a typical impression material flow channel configuration of a typical single arch bite fork substrate.

FIG. 12 illustrates a typical edentulous gum configuration where inserts have been implanted to receive a denture set at both maxillary and mandibular surfaces of a patient.

FIG. 13 illustrates a typical flow chart of the steps involved in a typical process for use of one of the embodiments of the invented system.

FIG. 14A illustrates an optional embodiment of FIG. 2 with integrated connection between the bite fork and part of the mixer unit outlet.

FIG. 14B illustrates a perspective view of the optional embodiment of FIG. 14A with focus on the integrated connection.

FIG. 15 illustrates an optional embodiment of FIG. 8 with integrated connection between the bite fork and part of the mixer unit outlet.

FIGS. 16A, 16B, and 16C illustrate photographs of perspective view, top view, and bottom view respectively of a typical bite fork disclosed after pumping the impression material through the substrate and obtaining a patient's bite impression registration on the same.

FIG. 16D is a close-up view of FIG. 16C.

FIG. 16E and FIG. 16F are example perspective view photographs as seen from the end side of FIG. 16A.

FIG. 17A and FIG. 17B are photographs of top view and bottom view respectively of a bite fork drawing illustrated in FIG. 2.

FIG. 17C and FIG. 17D are photographs of top view and bottom view respectively of a version of bite fork similar to the drawing illustrated in FIG. 2 but with optional alternate configuration of cylindrical hole openings instead of slot shaped openings.

FIG. 18 illustrates a slightly curved bite fork after registering a curvature of bite or occlusion.

FIG. 19 illustrates an example of a partial configuration of a bite fork or tray.

FIG. 20 illustrates an example of a bite tray providing a thin mesh at the middle part to facilitate close proximity of maxillary and mandibular arches during a bite.

### DETAILED DESCRIPTION OF THE INVENTION

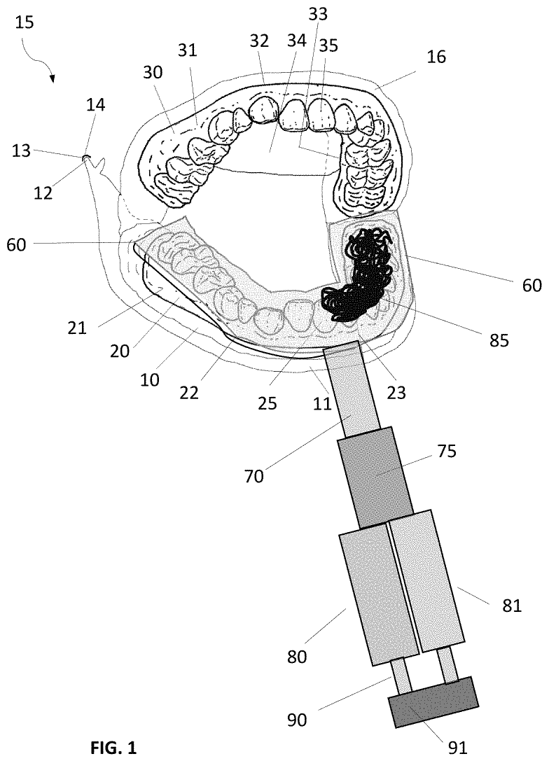

FIG. 1 illustrates an overall assembled block diagram view of an embodiment of the invention used in conjunction with a full set of mandibular denture 20 and maxillary denture 30, having a bite fork substrate 60 inserted between them, a connection 70 to source of one or more constituents of impression material through a mixer unit 75, the sources of impression material 80 and 81, a piston rod 90, a pressure application thimble 91, and a representative amount of impression material 85 pumped over the substrate of the bite fork. The bite fork substrate may be provided with a snap fit, threaded, or a clamping mechanism such as a worm clamp or spring clamp for ease of connectivity and dis-connectivity between the substrate and the impression material source thus facilitating modularity and multiple times use. The snap fit may be of different configurations and shapes such as a cylindrical, taper, spherical or other geometries that may allow the connection to be rigid or flexible according to requirements. Alternatively, an integrated version was found to have better reliability when pressurizing the flow of impression material through the system, as it cannot get disconnected undesirably. The impression materials source may be integrated with a manual pumping mechanism to pressurize the flow of the material into the bite fork. Additionally, and optionally, the pumping mechanism may be motorized by integration of a miniaturized electric pump. Those skilled in the art may appreciate that there can be several configurations of locations of integration of the pump with the impression materials source and the bite fork substrate, for example, direct pressurization of impression material or indirect pressurization such as through air or hydraulic pressure from a relatively distant location, enabling the bite fork assembly to be light and compact while held inside a person's oral cavity. Optionally, and in addition, the integrated pumping means with impression material may be a single use and throw type optional embodiment.

The figure shows a configuration of mandibular and maxillary dentures in relation with the lower and upper jaws of a user respectively, pointing out the locations of different anatomical parts of interest in view of the disclosed inventive aspects of a bite fork for bite registration. The jaws of user are shown in an open state to be able to view the internal parts of oral cavity of the user, along with a view of a bite fork substrate inserted and held between them. The lower jaw has lower gum (also called gingiva) part 10 placed over a bone structure 11 in the mandible. The bone structure extends to the back as a Temporomandibular Joint (TMJ) 15 comprising of parts known in the art as condyle 12, fossa 13, and disc 14. The mandibular denture 20 is placed over the lower gum 10 in a reasonably tight but comfortable fit and remains retained during day-to-day activities of the user such as speaking, chewing, etc. In a standard denture that does not use any implants to secure the denture to the mandible, the shape and fit between the mandible and the mandibular denture serve the purpose of retention.

The user is generally provided with options for increased levels of retention, for example, by inserting or applying between denture 20 and gum 10 bio-compatible human use safe adhesive materials claiming several characteristics such as being Zinc free, impervious to water, providing soft cushion, quality seal from food particles, ooze-control, use of natural ingredients like gum wax, beneficial herbs, and vitamins. Several adhesive products are available, for example, Effergrip® denture adhesive cream (manufacturer: Prestige Consumer Healthcare, Irvington, N.Y.; Source: Amazon® USA), Fixodent® Ultra Max Hold Dental Adhesive (Procter & Gamble®, Cincinnati, Ohio, USA), SECURE® Sensitive Adhesive (Cutting Edge International, LLC, Los Angeles, Calif., USA), Instant Smile™ Secure Fit Adhesive (Billy Bob Products Inc., Hardin, Ill., USA), Super Poligrip® Denture and Partials Adhesive Cream (Glaxo Smith Kline, Philadelphia, Pa., USA), Corega® Denture Adhesive Cream (Glaxo Smith Kline, Bulgaria, Source: Amazon®, USA), Y-Kelin Denture Adhesive Cream (Anhui Greenland Biotech Co. Ltd., Bengbu, Anhui, China), DenSureFit® Lower Denture Reline Kit (OTC Dental Inc., Vancouver, Wash., USA), and from many other manufacturers or sources.

The use of adhesive between denture and gum is found to achieve good average retention force in compliance with reported research, for example, in the range of 16.66±7.32 lbs for milled denture bases and in the range of 12.19±6.15 lbs for the conventional heat polymerized denture bases (AlHelal, Abdulaziz Abdullah, “Comparison of Retention between Milled and Conventional Denture Bases: A Clinical Study” (2016), Loma Linda University Electronic Theses, Dissertations & Projects, 323). Our experimental tests have shown that 3D printed dentures provide better or at least comparable retention force relative to milled denture bases. We have found that this retention force is adequate to withstand the mandibular advancement force reported in the art as approximately 1 to 1.2 Newtons per millimeter of mandibular advancement (for example, 1.18 Newtons per millimeters as per J Cohen-Levy, B Pételle, J Pinguet, E Limerat, B Fleury, Sleep Breath, 2013 May; 17(2):781-9. doi: 10.1007/s11325-012-0765-4. Epub 2012 Sep. 11).

The mandibular denture 20 comprises of an exterior wall or flange 21, an exterior ridge or border 22, and an interior ridge or border 23. A cavity known in the art as trough is formed between the exterior and interior walls that fits over the lower gum 10. A set of teeth 25 that substitute natural teeth known in the art with nomenclature (starting from back or TMJ side, a set of teeth—one on left and one on right sides) Second Molar, First Molar, Second Premolar, First Premolar, Canine or Cuspid, Lateral Incisor, and Central Incisor (front most teeth set) are embedded symmetrically in the mandibular denture in a U-shaped configuration. This is considering the prevailing trend of not having Third Molar or Wisdom teeth at the back most location, like the natural teeth set where their extraction is recommended by dentist profession, resulting in a total fourteen teeth in the mandibular denture.

Analogous to the mandibular denture 20, the maxillary denture 30 comprises of an exterior wall or flange 31, an exterior ridge or border 32, and an interior ridge or border 33. A cavity known in the art as trough is formed between the exterior and interior walls that fits over the upper gum 16. Generally, an impression of upper palate of user's oral cavity is obtained to provide a bridge between the left and right sides of interior walls in the maxillary denture. This bridge part known as Palate 34 generally is in close contact with the user's upper palate helping in improved retention of the maxillary denture. The maxillary denture 30 is placed over the upper gum 16 in a reasonably tight but comfortable fit and remains retained during day-to-day activities of the user such as speaking, chewing, etc. In a standard denture that does not use any implants to secure the denture to the maxilla, the shape and fit between the maxilla and the maxillary denture along with palatal contact serve the purpose of retention. The user is generally provided with options for increased levels of retention, for example, by inserting or applying between denture 30 and gum 16 bio-compatible human use safe adhesive materials claiming several characteristics as mentioned earlier in the context of mandibular denture. A set of teeth 35 that substitute natural teeth known in the art with nomenclature (starting from back or TMJ side, a set of teeth—one on left and one on right sides) Second Molar, First Molar, Second Premolar, First Premolar, Canine or Cuspid, Lateral Incisor, and Central Incisor (front most teeth set) are embedded symmetrically in the maxillary denture in a U-shaped configuration. This is considering the prevailing trend of not having Third Molar or Wisdom teeth at the back most location, like the natural teeth set where their extraction is recommended by dentist profession, resulting in a total fourteen teeth in the maxillary denture.

While a case with full dentures using a bite fork for bite registration described above is useful to check the suitability of an existing or old denture, and to design and manufacture a better fitting, updated or new denture set, the invented bite fork under current disclosure has broader applications for those with full natural teeth. In those cases, we may consider FIG. 1 without the denture related features such as 30-34 in the maxilla and 20-23 in the mandible. A set of teeth 35 in the maxilla and set of teeth 25 in the mandible will be natural teeth known in the art with nomenclature (starting from back or TMJ side, a set of teeth—one on left and one on right sides) Second Molar, First Molar, Second Premolar, First Premolar, Canine or Cuspid, Lateral Incisor, and Central Incisor (front most teeth set) are embedded symmetrically in the maxillary jaw and mandibular jaw respectively in a U-shaped configuration.

The configuration of FIG. 1 may also be used in an edentulous case where there are no natural teeth in the maxillary or mandibular jaws of a patient and the person does not have any functional usable dentures at present. In such cases, the bite fork will come into direct contact with the lower gum 10, or the upper gum 16, or typically both lower and upper gums during a bite down over the bite fork substrate to realize the bite registration.

The disclosed bite fork or bite tray may be more conveniently used by dental professionals including dentists, orthodontists, prosthodontists, denturists, etc. for prescription of a variety of orthodontic appliances such as aligners, retainers, night guards or mouth guards, sleep apnea treatment oral appliances (e.g. Mandibular Advancement Devices or Stents), anti-snoring devices, dentures, and several others. The disclosed bite fork or bite tray may also be used in conjunction with an analog or digital face bow. A bite fork may also be self-administered by a user or patient in a home or clinical setting, likely following instructions from a professional. It may be sent to a patient as a kit either stand-alone or as part of an impression tray kit.

Broadly, a preferred embodiment of disclosed system is useful for obtaining inside a person's oral cavity a bite registration consisting of full or partial teeth impression or full or partial gum impression or alveolar bone or alveolar process or alveolar ridge or a combination of these. Edentulous maxillary and mandibular Jaw Segments (EJS) consist of alveolar and basal bone. EJSs are attributed to non-aesthetic and aesthetic maxillary or mandibular zone, because the requirements and risks of aesthetic result achievement differ significantly in so called non-aesthetic zone in comparison with aesthetic zone. Alveolar bone or alveolar process or alveolar ridge are terms used to capture the relationship of associated soft tissue or exposed surface layer with respect to the dentition of a person or patient.

In an additional optional embodiment, the disclosed system may also be used for functioning as a dental impression tray. In such an optional embodiment, additional enclosure means to constrain the flow of the impression material around the teeth or gums is deployed to control and enhance the contact pressure between the teeth or gums or alveolar bone or alveolar process or alveolar ridge and the impression material in order to obtain a relatively more accurate and representative impression.

The bite registration obtained and/or dental arch impression obtained is directed towards bite or occlusion classification, or jaw classification, or both bite and jaw classification useful for prescribing or designing or manufacturing of denture set such as Removable Partial Dentures or Removable Full Dentures, or useful for manufacture of oral appliances worn over either natural or prosthetic teeth or a combination in case of anti-snoring devices, mandibular advancement devices, aligners, or mouth guards or plurality of oral appliances.

Three different bite fork types and uses are disclosed; namely, edge to edge dual arch, non-edge to edge dual arch, and single arch. The edge to edge dual arch type can be deployed where the incisors of the upper and lower arch meet in a parallel path or aligned to each other. The non-edge to edge dual arch type of bite fork may be deployed where it is desired that patients can bite in any position including fully retruded, natural, to fully protruded or maximum advanced. The dual arch bite forks are generally used for obtaining the bite registration or impression or to obtain therapeutic position for dual arch appliances such as mandibular advancement devices (MADs) or night guards or mouth guards that cover both upper and lower arch. An appropriate therapeutic position of an oral appliance is defined as a position of the mandible that achieves improvement of symptoms, signs, or objective indices of disorders that are related to sleep and breathing such as Obstructive Sleep Apnea.

The single arch type of bite fork is generally meant to be used for obtaining the bite registration or impression or to obtain therapeutic position for single arch appliances such as a mouth guard or night guard for only one of maxillary or mandibular arch. It may be deployed where patients can bite in any position including fully retruded, natural to fully protruded or maximum advanced. However, in an additional optional embodiment it is possible to use it for registration of dual arch (both maxillary and mandibular parts) too.

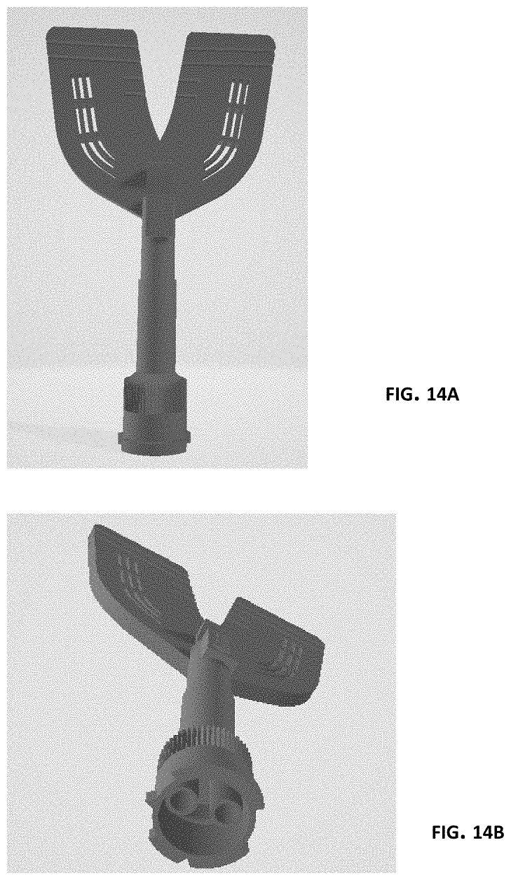

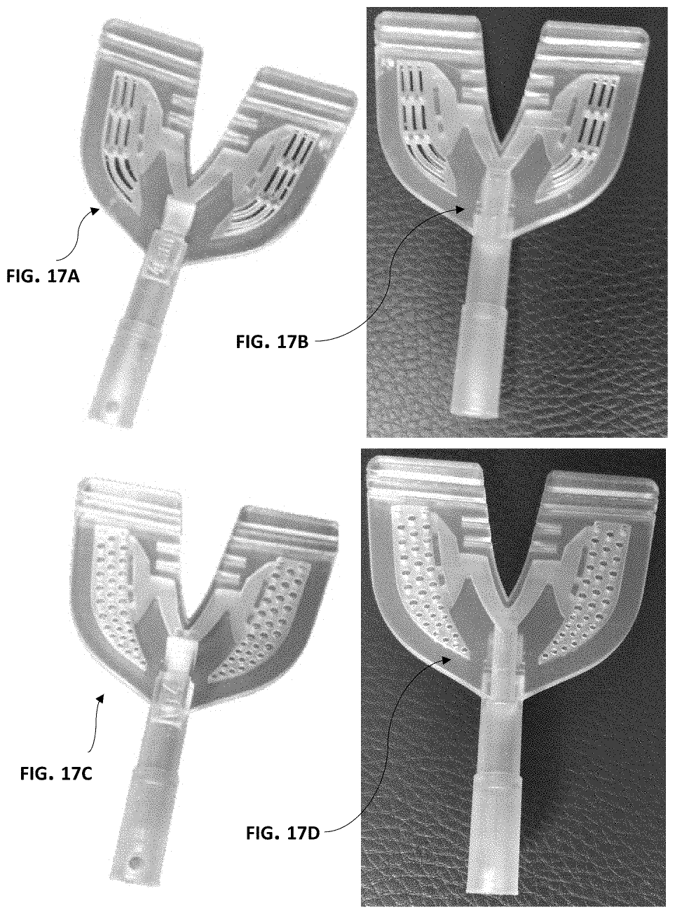

FIG. 2 presents a perspective view of a typical non edge to edge dual arch bite fork substrate 200 wherein the horse-shoe shape corresponding to a typical mandibular or maxillary arch is represented by its part 210, the handle part 215 having connectivity with the bite registration impression material or other purpose impression material source. This handle part 215 represents the connection means 70 shown in FIG. 1, and may be connected through a joint, or integral with a part of the mixer 75 (FIG. 14A, 14B). Openings 211 in the bite fork represent the exit locations of impression material when pumped from the source through channels that can be viewed in a sectional view (FIG. 5). These openings may be of different shapes, for example, in the form of slots as shown in FIG. 2, but several other shapes may be deployed, such as circular openings with cylindrical pipe type channels as shown in another optional configuration (Photographs FIGS. 17C and 17D). The substrate provided is a single substrate that can be expanded according to the size of the person's mandibular or maxillary arch and in addition optionally shortened by means of separating, clipping, or breaking one or more ends of the substrate as illustrated in the Figure at the breaking or clipping groove lines 212. Moreover, groves provided on the substrate surface, such as 213, help in retention of impression material while it flows out from the openings, and thus are called retention lines. A notch is formed by a projected portion 214 on only one side of the substrate in a non edge to edge bite fork as only one of maxillary or mandibular teeth set is expected to bite into the notch while the other set is free and bites into a plain surface of the bite fork on the other side.

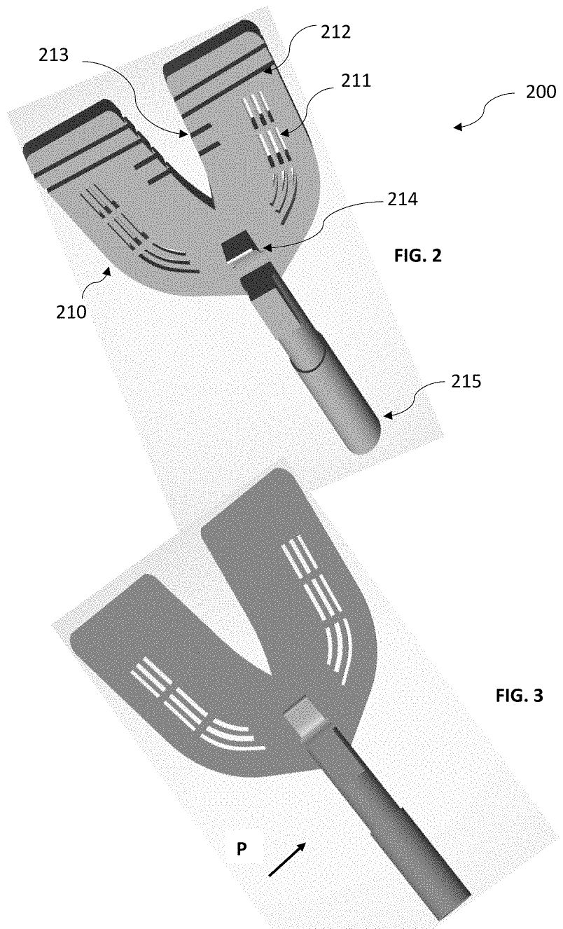

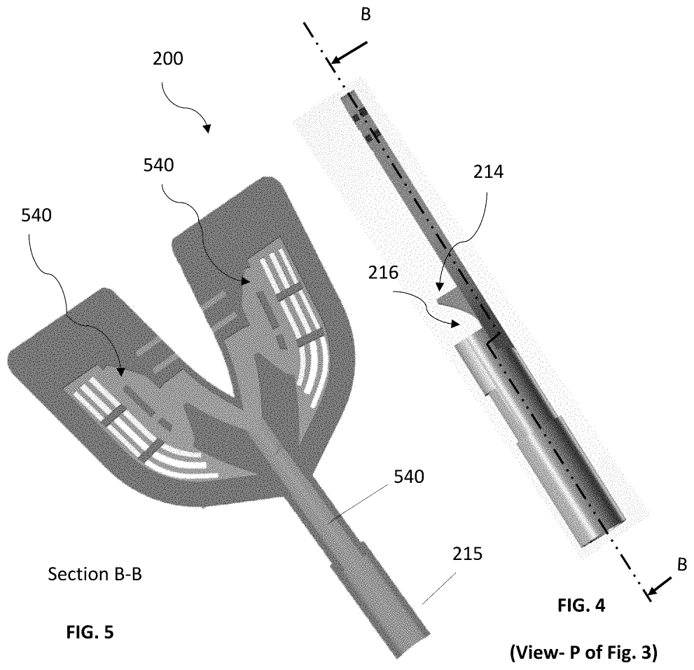

FIG. 3 shows a plain top view of the FIG. 2, while FIG. 4 shows a lateral or side view-P of FIG. 3. The notch formed by the projected portion 214 shown in FIG. 2, is more clearly visible in FIG. 4 as 216. A sectional view at section B-B of FIG. 4 illustrating a typical impression material flow channel configuration of a typical non edge to edge dual arch bite fork substrate is depicted in FIG. 5. Photographs of top view and bottom view of a typical embodiment are presented in FIGS. 17A and 17B. Furthermore, FIG. 17C and FIG. 17D are photographs of top view and bottom view respectively of a version of bite fork similar to the drawing illustrated in FIG. 2 but with optional alternate configuration of circular hole openings instead of slot shaped openings.

It may be appreciated that the channel path and design 540 is only an example, and there may be several different patterns of the same, all of them covered by the spirit and scope of this disclosure. The substrate may have a plurality of internal or external channels or combination of them for conveyance of the bite registration material or impression material and multiple openings for the material to eject from the openings. Although not shown in this Figure, channels may also be external wherein retention and flow of material is achieved by gravity. Furthermore, optionally at least one or more deflectors, valves or other means or combinations of the same may be sequentially or concurrently deployed for enabling controlled distribution of ejection of the bite registration material or impression material from the different openings. In addition, optionally, the control of ejection of material is based on feedback from at least one or more sensors that are deployed in the channels or the substrate or any other part of flow path such as in the connection to the pumping means.

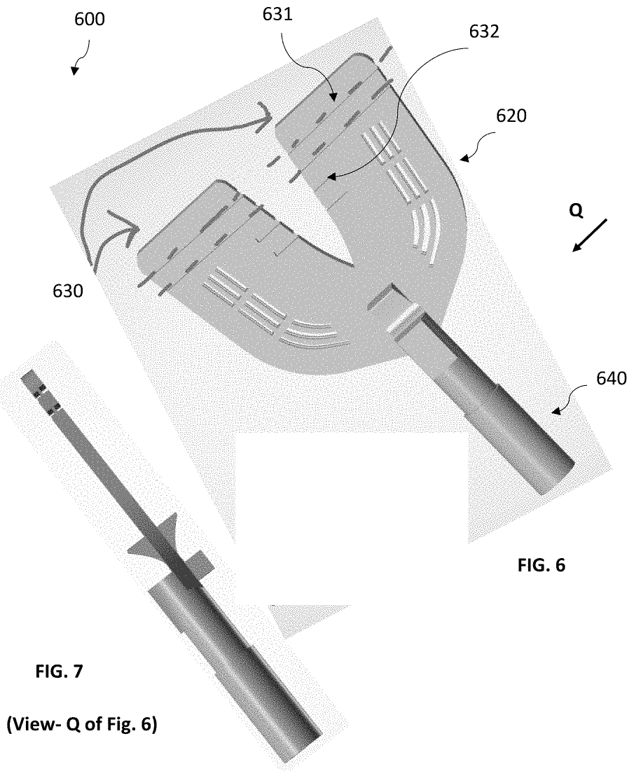

FIG. 6 shows a slightly perspective view (nearly top view) of a typical edge to edge dual arch bite fork substrate 600 wherein the horse-shoe shape corresponding to a typical mandibular or maxillary arch is represented by its part 620, the handle part 640 having connectivity with the bite registration impression material or other purpose impression material source. The substrate provided is a single substrate that can be expanded according to the size of the person's mandibular or maxillary arch and in addition optionally shortened by means of separating, clipping, or breaking one or more ends 630 of the substrate as illustrated in the Figure at the chain—dotted lines. The grooves 631 on the substrate facilitate the provision for the clipping off. Moreover, groves provided on the substrate surface, such as 632, help in retention of impression material while it flows out from the openings, and thus are called retention lines. FIG. 7 shows a lateral or side view-Q of FIG. 6. It is clear in this figure that a typical edge to edge dual arch bite fork substrate of this disclosure comprises of notches formed on both sides of the substrate, distinct from the non edge to edge embodiment in which only one side has the notch.

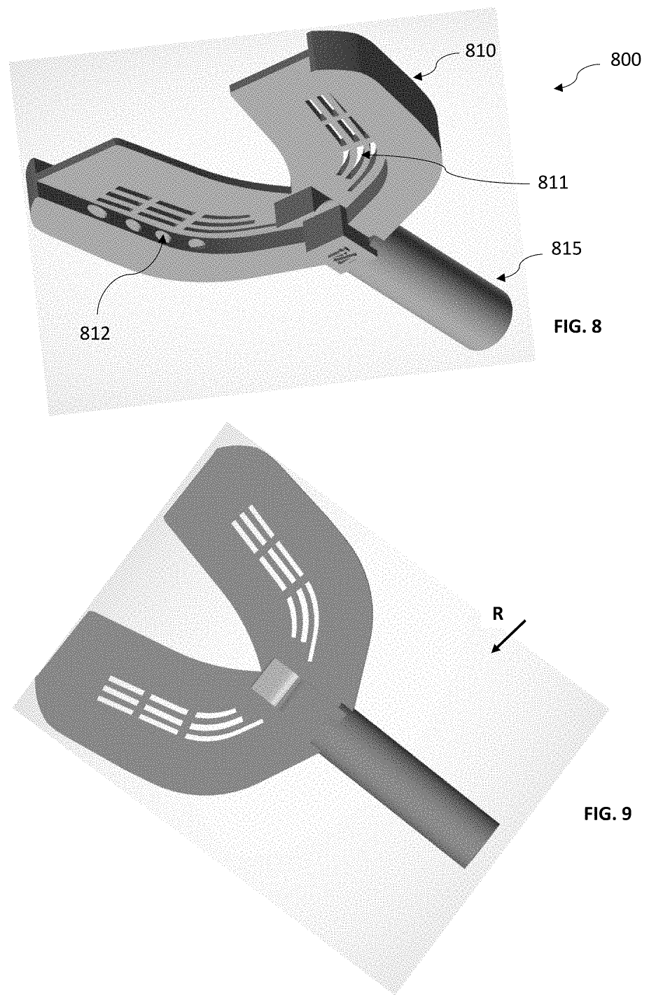

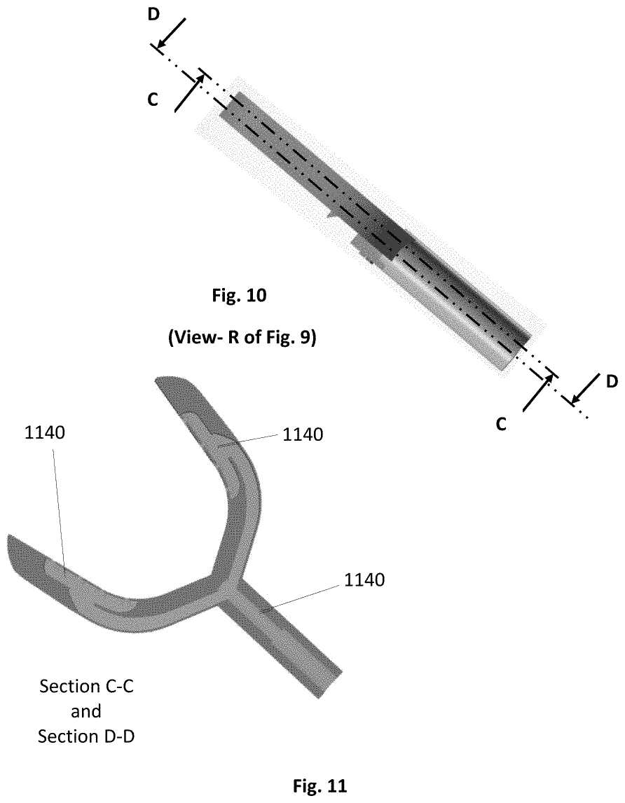

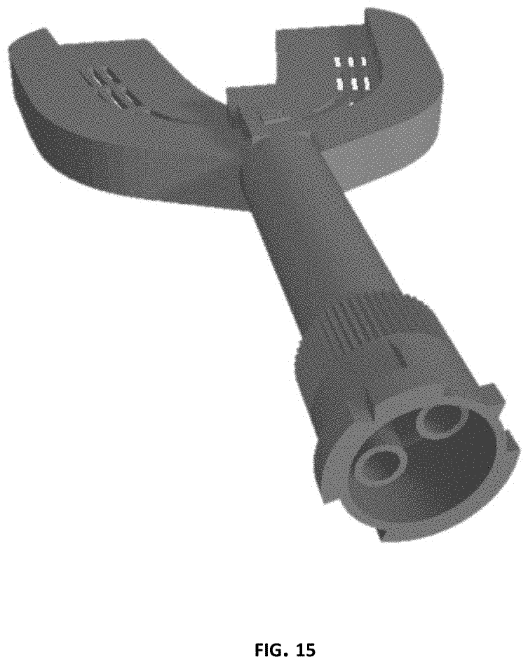

FIG. 8 presents a perspective view of a typical single arch bite fork substrate 800 wherein the horse-shoe shape corresponding to a typical mandibular or maxillary arch is represented by its part 810, the handle part 815 having connectivity with the bite registration impression material or other purpose impression material source. A part of mixer outlet is integral with the handle in an optional embodiment (FIG. 15). Openings 811 and 812 in the bite fork represent the exit locations of impression material when pumped from the source through channels 1140 that can be viewed in a sectional view (FIG. 11). FIG. 9 shows a plain top view of the FIG. 8, while FIG. 10 shows a lateral or side view-R of FIG. 9.

FIG. 11 shows a Sectional view at section C-C of FIG. 10 illustrating a typical impression material flow channel configuration 1140 of a typical single arch bite fork substrate. It may be appreciated that the channel path and design 1140 is only an example, and there may be several different patterns of the same, all of them covered by the spirit and scope of this disclosure. The substrate may have a plurality of internal or external channels or combination of them for conveyance of the bite registration material or impression material and multiple openings for the material to eject from the openings. Although not shown in this Figure, channels may also be external wherein retention and flow of material is achieved by gravity. Furthermore, optionally at least one or more deflectors, valves or other means or combinations of the same may be sequentially or concurrently deployed for enabling controlled distribution of ejection of the bite registration material or impression material from the different openings. In addition, optionally, the control of ejection of material is based on feedback from at least one or more sensors. Moreover, it may be appreciated by those skilled in the art that a single arch bite fork substrate also may have different optional configurations such as non edge to edge as well as edge to edge by providing notches on either only one side or both sides of the substrate.

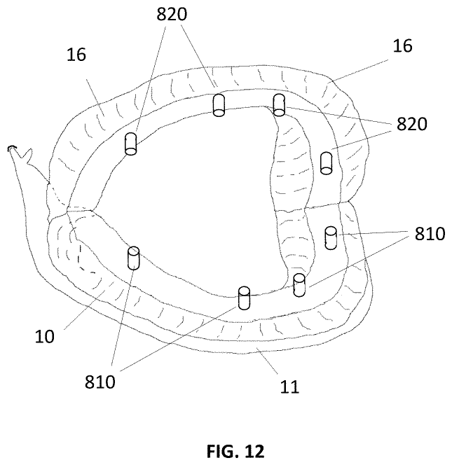

FIG. 12 illustrates a typical edentulous gum configuration where inserts 810 and 820 have been implanted to receive a denture set at both maxillary and mandibular surfaces of a patient respectively. As mentioned earlier, a fully implant supported or fixed dentures are a few of the cases of application of bite fork registration, in addition to the denture configuration illustrated in FIG. 1. Other variants may also be possible, such as for prosthetic smile that could be made of porcelain or other materials.

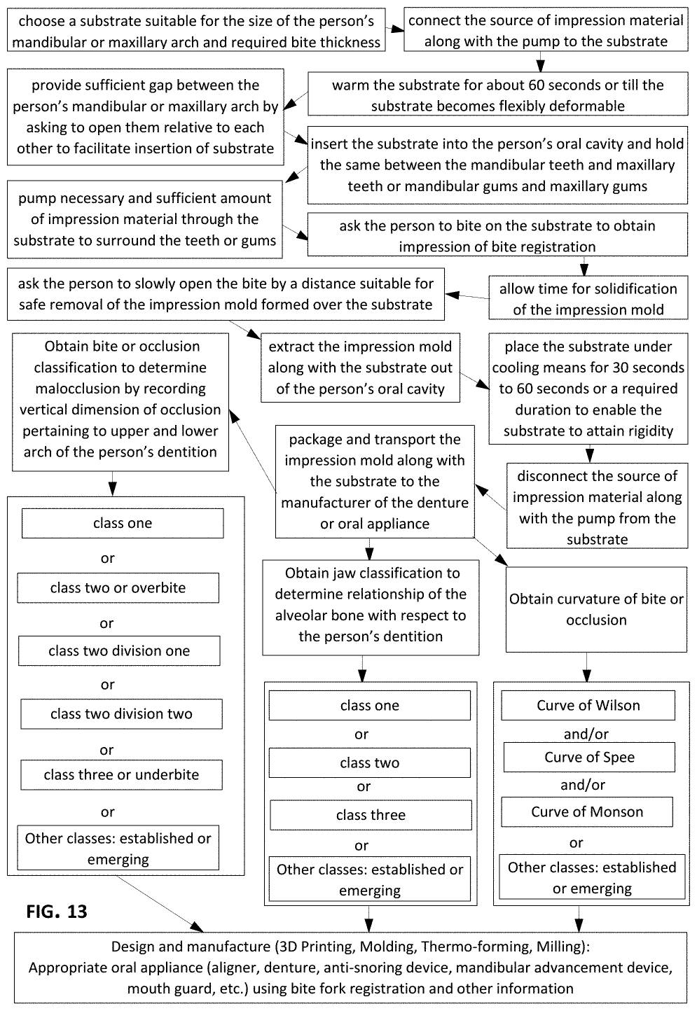

FIG. 13 illustrates a typical flow chart of the steps involved in a typical process for use of one of the embodiments of the invented system. It may be appreciated that the set and sequence of steps illustrated in the flow chart is only an example, and there may be several different alternative variants of the same, all of them covered by the spirit and scope of this disclosure. For example, substrate may be kept under warm water, or instead heated by other means such as warm air, for less or more time than mentioned in the flow chart. Similarly, for cooling, substrate may be kept under cold water, or instead cooled by other means such as cool air, for less or more time than mentioned in the flow chart, The sequence of events too may have variations, for example, an initial or preliminary curvature of bite or occlusion may be obtained by directly putting the warmed bite fork substrate into the oral cavity between the mandibular and maxillary arches and biting without connecting the source of impression material with the pump to the substrate. After obtaining a preliminary curvature of occlusion, the impression material source may be connected, and other steps may be undertaken as per the flow chart.

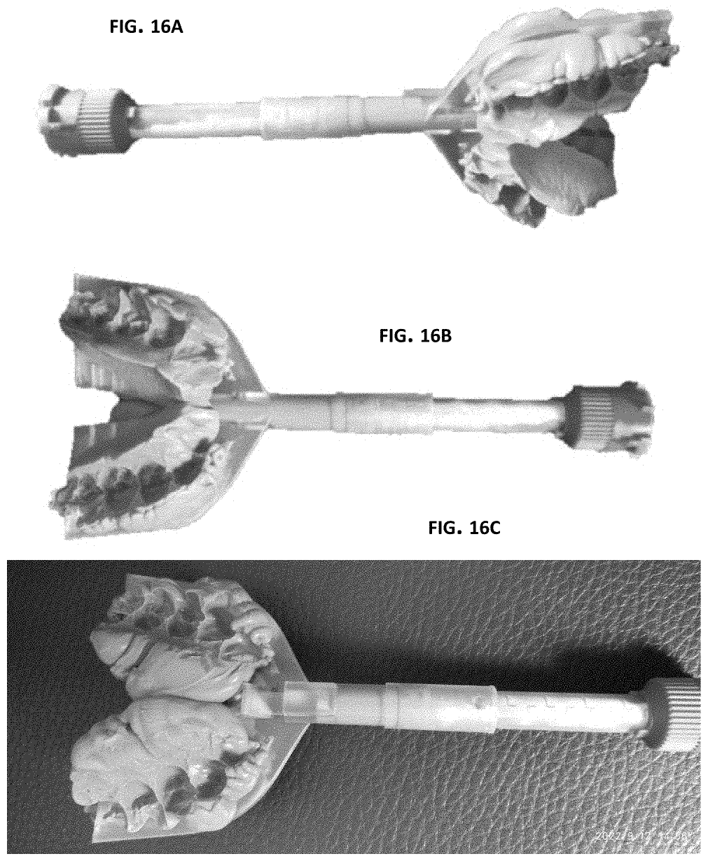

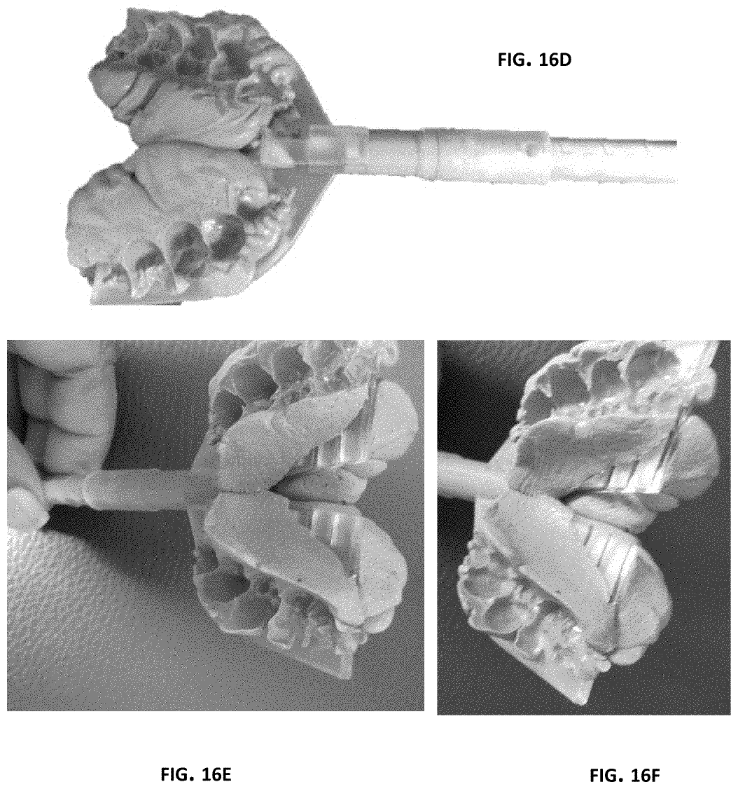

FIGS. 16A-16F illustrate several photographic views of an example of bite registration realized deploying one of the disclosed devices and methods.

It may be appreciated by those skilled in the art that features such as breaking lines, retention lines, integrated impression material source or mixer connection with substrate, and other several features are common optional features that are applicable to all the disclosed embodiments and their perceptible variants, and although they are illustrated and described as examples in particular embodiments in this description, application to all other variants are covered by the spirit and scope of disclosed invention.

We have experimented with several substrate materials, impression materials and their combinations, and several alternative means to connect the source of impression materials with the substrate both with and without exclusive mixer component.

The bite fork substrate may be made of light weight flexible bio-compatible material such as Nylon-12 or a stretchable bio-compatible elastomer. Broadly, the substrate may be made of plastic material such as bio-compatible Polyamides (e.g., Nylon-12, Nylon 6, Nylon 11, Nylon 66, Polyether Block Amide), Polyolefins (e.g., Polyethylene, Polypropylene, Cyclic Olefin Co-polymers, Polyvinyl Chloride), Polyesters (e.g., Poly butylene terephthalate, Poly ethylene terephthalate), Fluoropolymers (e.g., Polytetrafluoroethylene known with trade name Teflon, PVDF, FEP, ePTFE), Elastomers (e.g., Silicones, Thermoplastic elastomers), Poly-p-xylylene (Parylene), Polystyrenes (e.g., Polyformaldehyde, Polyurethanes), Biopolymers, and several other combinations and reinforced hybrid materials. The impression material pumped may be formed of multi-layer hybrid construction wherein a stronger (when solidified and hardened) impression material layer forms the core to provide strength and stability of impression areas in contact with teeth or gums over which softer impression material is layered allowing a combination of both strength as well as flexibility. The softer material, if constrained by barrier means surrounding the impression areas, may act as spring to ensure tighter and more compact and thus more accurate bite registration. The multi-layer construction may be achieved by several alternative pumping approaches such as simultaneous pumping of different impression materials from different channels, and sequential pumping of different impression materials from same channels.

In addition, optionally the bite forks may be provided in several different colors to assist in classification of the bite forks depending on size ranges. The color coding helps in ease of identification of a range with the size requirements of patients depending on their sizes of mandibular or maxillary arches.

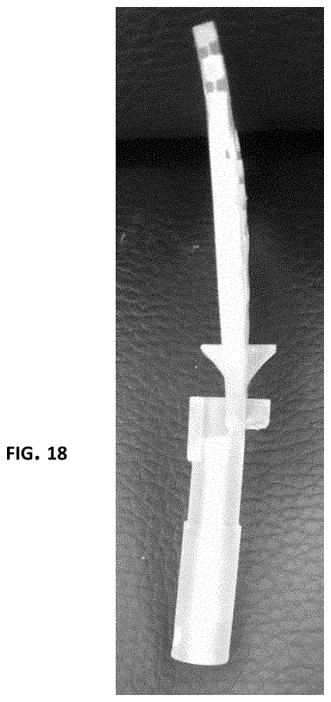

Preferably, but optionally, the bite fork substrate may be made of a bio-compatible thermoplastic such as Polyform, Methacrylate, or Ethylene Vinyl-acetate, such as Elvax 250, manufactured by DuPont®, Wilmington, Del., USA. A thermoplastic substrate becomes flexible when heated for about 60 seconds (for example, by placing under warm water or other alternate heating means such as placing in front of blower with hot air or any other warming means requiring less or more durations of time), then inserted in the oral cavity of a person, followed by bite by the person for a required duration to enable appropriate registration of bite curve, then removal from the oral cavity and optionally further cooled for a required duration (for example, by placing under cold water for 30 to 60 seconds, or other alternate cooling means such as placing in front of blower with cool air or any other cooling means requiring less or more durations of time) if necessary to enable the substrate to attain relatively higher rigidity for recording of said bite curve registration. FIG. 18 illustrates an example photograph of an edge to edge bite fork (having notches at both sides of the substrate) that has obtained a curved shape when after being warmed, it was inserted inside oral cavity between maxillary arch and mandibular arch of a patient and bite was done, the fork taken out and cooled adequately to make it rigid and thus retain the bite curve registration. FIG. 7 illustrates the original straight configuration of this bite fork before attaining the curvature. In addition, optionally the substrate may change color when transforming from flexible state to relatively less flexible state. It is advantageous that there is a color or shade change when the rigidity or softness of substrate changes from one state to other, as it makes the identification of the state of rigidity easier by visual inspection. A few of the prototypes were fabricated by 3D printing or additive manufacturing using hard and soft resin (e,g. Keysplint-hard and Keysplint-soft from Keystone Industries, Gibbstown, N.J., USA), whereas injection molding and milling were also deployed.

A variety of bite registration impression materials may be used for bite fork registration or other impression materials for capture of left or right side of a patient's upper or maxillary, and/or lower or mandibular arch. Vinyl Poly Siloxane (VPS), Poly Vinyl Siloxane (PVS), and Alginates are most commonly used. Broadly, impression materials are classified as rigid or inelastic and elastic. Rigid or inelastic impression materials include impression plasters, impression compounds, impression waxes and Zinc Oxide Eugenol. Elastic impression materials include Hydrocolloids such as reversible Agars and irreversible Alginates. Elastomeric impression materials include Polyether, Condensation Silicone, Polyvinyl Siloxane, and Polysulfide.

A few examples used during prototype experiments of the disclosure are as follows. Alginate impression material Cavex ColorChange™ has elastic and color changing properties (Cavex Holland B V, Haarlem, Netherlands). It turns from violet to pink that indicates end of mixing time (in 30 to 60 seconds), turns from pink to white that indicates end of setting time (in about 60 seconds), and turns from white to pink to indicate that the impression is fully cured (in about 30 minutes time). Several varieties of Maxill® products (Maxill, St. Thomas, Ontario, Canada) and Henry Schein® products (Henry Schein, Melville, N.Y., U.S.A.) were also experimented along with several other brands available internationally. The bite registration materials or impression materials used with the system were typically semi-solids or liquids that solidify after some time or mixture of multiple liquids or mixture of liquid and solid substances that solidified after some time, for example, after 30 seconds to 30 minutes.

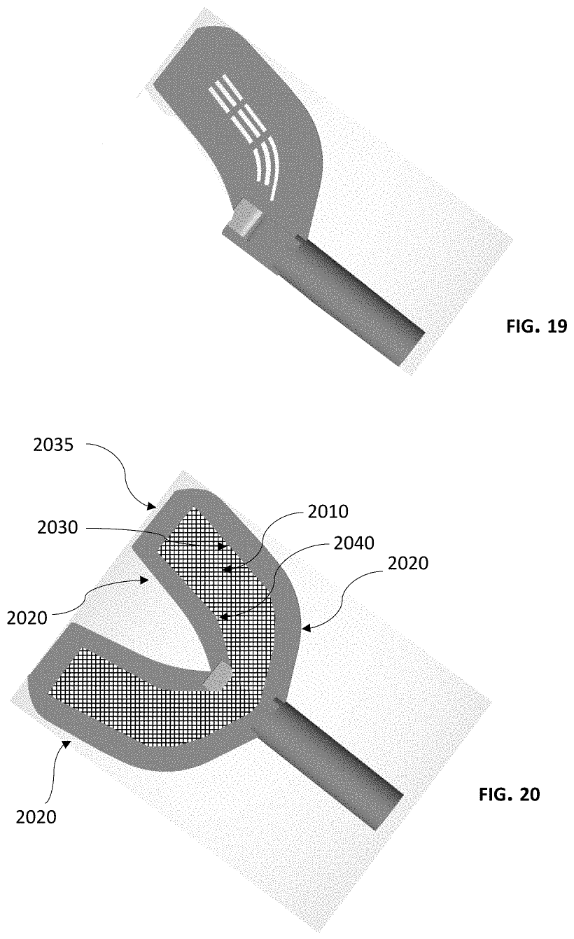

It may also be appreciated by those skilled in the art that additional and optional configurations of the disclosed invention may enable embodiments as variants for additional specific functionalities, covered by the spirit and scope of disclosed invention. For example, in a variant (FIG. 19), only half of the horse-shoe shape may be provided to capture the impression of only part of a dentition for bite registration. As another example, a bite tray variant (FIG. 20) may have a thin mesh 2010 between ridges 2020 of horse-shoe shape enabling close contact between the mandibular and maxillary arches, wherein impression material flows from either the openings on the exterior side of wall 2030 of the horse-shoe shaped ridge or the material circulates around a loop 2035 (the loop may pass from a recess such as extracted wisdom teeth or other missing teeth) of the ridge to enable flow of impression material from openings of at least part of the interior wall 2040.

We claim:

1. A system for obtaining inside a person's oral cavity a bite registration or impression consisting of full or partial teeth impression or full or partial gum impression or alveolar bone or alveolar process or alveolar ridge or a combination of these comprising of
a means to hold impression material on at least one or more sides or surfaces of a substrate inserted into the oral cavity and held between the mandibular teeth and maxillary teeth or mandibular gums and maxillary gums;
a means to facilitate flow of said impression material through the substrate;
a means to connect source of impression material to the substrate; and
a means to pump the impression material around the gums or teeth or both forming their impression.

2. The system of claim 1, wherein the substrate is made of plastic material such as bio-compatible Polyamides, Polyolefins, Polyesters, Fluoropolymers, Elastomers, Thermoplastics, Poly-p-xylylene, Polystyrenes, Biopolymers, or several other combinations or reinforced hybrid materials, and in addition optionally provided in several different colors.

3. The system of claim 1 wherein the substrate becomes flexible when heated, then inserted in the oral cavity of a person, followed by bite by the person for a required duration to enable appropriate registration of bite curve, then removal from the oral cavity and optionally further cooled for a required duration if necessary to enable the substrate to attain relatively higher rigidity for recording of said bite curve registration, and in addition optionally the substrate changes color when transforming from flexible state to relatively less flexible state.

4. The system of claim 3 wherein said registration of bite curve is Curve of Wilson, or Curve of Spee, or Curve of Monson, or other Curves of interest, or a plurality of such curve registrations.

5. The system of claim 1 wherein the substrates provided are a set of different widths and lengths suitable for the size of the person's mandibular or maxillary arch and substrate thickness ranging from 0.5 millimeters to 10 millimeters suitable for verifying Vertical Dimension of Occlusion (VDO) of the person and in addition optionally verifying freeway space, and in addition optionally therapeutic oral position or a combination of these suitable for specific oral appliance being prescribed, designed or manufactured.

6. The system of claim 1 wherein the substrate provided is a single substrate that can be expanded according to the size of the person's mandibular or maxillary arch and in addition optionally shortened by means of separating, clipping, or breaking one or more ends of the substrate.

7. The system of claim 1 wherein the substrate has at least one internal channel for conveyance of the bite registration material or impression material and at least one opening for the bite registration material or impression material to eject from the opening.

8. The system of claim 1 wherein the substrate has plurality of internal or external channels or combination of them for conveyance of the bite registration material or impression material and multiple openings for the material to eject from the openings, and in addition at least one external channel serves the purpose of retention of said material constraining it from flowing beyond the retention channel or groove.

9. The system of claim 8 wherein at least one or more deflectors, valves or other means or combinations of the same are sequentially or concurrently deployed for enabling controlled distribution of ejection of the bite registration material or impression material from the different openings, optionally, said control of ejection of material is based on feedback from at least one or more sensors.

10. The system of claim 1, wherein the bite registration material or impression material used with the system is semi-solid or liquid that may solidify after some time or mixture of multiple liquids or mixture of liquid and solid substances that solidify after some time.

11. The system of claim 1, wherein the means to connect source of bite registration material or impression material to the substrate comprises of a mixer to mix a plurality of constituents of the impression material.

12. The system of claim 1, wherein the means to connect source of impression material to the substrate comprises of a snap fit or a threaded fit or a clamp fit, and in additional optionally said means may be either integrated with the substrate or be detachable.

13. The system of claim 1, wherein
the substrate may be configured to obtain only a part of bite registration or impression, such as half of an arch or other partial configurations, or
the substrate may be configured with a thin mesh at middle enclosed by ridge on one or more sides, to facilitate closer bite, or
additional enclosure means to constrain the flow of the impression material around the teeth or gums is deployed to control and enhance the contact pressure between the teeth or gums or alveolar bone or alveolar process or alveolar ridge and the impression material in order to obtain a relatively more accurate and representative impression.

14. The system of claim 1, wherein the bite registration obtained is directed towards bite or occlusion classification, or jaw classification, or both bite and jaw classification useful for prescribing or designing or manufacturing of denture set such as Removable Partial Dentures or Removable Full Dentures, or useful for manufacture of oral appliances worn over the teeth such as aligners, anti-snoring devices, mandibular advancement devices, or mouth guards or plurality of appliances.

15. The system of claim 1, wherein at least one or more constituent parts are made by 3D printing or additive manufacturing process.

16. The system of claim 1, wherein all constituent parts are made by 3D printing or additive manufacturing process or injection molding process.

17. The system of claim 13, wherein the impression material mold formed by the pumping of impression material around the teeth or gums is made of multi-layer hybrid construction wherein a stronger material layer is core to provide strength of the impression over which a relatively softer and more flexible bio-compatible material is pumped subsequently facilitating the compression for said enhanced contact pressure.

18. A process for use of the system of claim 1 for prescription or design or manufacture of an appliance by providing the steps
choose a substrate width and length suitable for the size of the person's mandibular or maxillary arch and substrate thickness suitable for verifying Vertical Dimension of Occlusion (VDO) or verifying Freeway space or verifying therapeutic oral position or a combination of these for the appliance;
connect the source of bite registration material or impression material along with the pump to the substrate;
provide sufficient space between the person's mandibular or maxillary arch by asking to open the arches relative to each other to facilitate insertion of substrate;
insert the substrate into the person's oral cavity and hold the substrate between the mandibular teeth and maxillary teeth or mandibular gums and maxillary gums or alveolar bone or alveolar process or alveolar ridge or a combination of these;
pump necessary and sufficient amount of bite registration material or impression material through the substrate to surround the teeth or gums;
ask the person to bite on the substrate to obtain one or more impressions of following bite registrations
bite down in natural position and/or
bite down in edge-to-edge position and/or
bite down in maximum mandibular advancement position and/or
bite down in a desired intermediate and/or therapeutic position;
bite down in maximum retruded position;
allow time for solidification of impression mold;
ask the person to slowly open the bite by a distance suitable for safe removal of the impression mold formed over the substrate;
extract the bite registration mold or impression mold along with the substrate out of the person's oral cavity;
disconnect the source of bite registration material or impression material along with the pump from the substrate;
package and transport the bite registration or impression mold along with the substrate to the prescriber, designer or manufacturer of oral appliance or denture.

19. A process for use of the system of claim 3 by providing the steps
choose a substrate width and length suitable for the size of the person's mandibular or maxillary arch and substrate thickness suitable for verifying Vertical Dimension of Occlusion (VDO) or verifying Freeway space or verifying therapeutic oral position or a combination of these for the appliance;
connect the source of bite registration material or impression material along with the pump to the substrate;
place the substrate under heating condition for about 60 seconds or till the substrate becomes flexibly deformable;
provide sufficient space between the person's mandibular or maxillary arch by asking to open the arches relative to each other to facilitate insertion of substrate;
insert the substrate into the person's oral cavity and hold the substrate between the mandibular teeth and maxillary teeth or mandibular gums and maxillary gums or alveolar bone or alveolar process or alveolar ridge or a combination of these;
pump necessary and sufficient amount of impression material through the substrate to surround the teeth or gums;
ask the person to bite on the substrate to obtain one or more impressions of following bite registrations
bite down in natural position and/or
bite down in edge-to-edge position and/or
bite down in maximum mandibular advancement position and/or
bite down in a desired intermediate and/or therapeutic position and/or
bite down in maximum retruded position;
allow time for solidification of impression mold;
ask the person to slowly open the bite by a distance suitable for safe removal of the bite registration mold or impression mold formed over the substrate;
extract the bite registration mold or the impression mold along with the substrate out of the person's oral cavity;
place the substrate under cooling condition for 30 seconds to 60 seconds or a required duration to enable the substrate to attain rigidity;
disconnect the source of impression material along with the pump from the substrate; and
package and transport the impression mold along with the substrate to prescriber or designer or manufacturer of denture or oral appliance, and additionally or alternatively
scan the impression mold using a multi-dimensional scanner and send the scan information in a digital format to prescriber or designer or manufacturer of oral appliance or denture.

20. The process of claim 19 wherein one or more of following are obtained
bite or occlusion classification to determine malocclusion by recording vertical dimension of occlusion pertaining to upper and lower arch of the person's dentition comprising of five types of classes including class one, class two or overbite, class two division one, class two division two, and class three or underbite, or other emerging classes;
jaw classification to determine relationship of the alveolar bone with respect to the person's dentition comprising of three types of classes including class one, class two, and class three, or other emerging classes;
curvature of bite or occlusion comprising of three types of curves including Curve of Wilson, or Curve of Spee, or Curve of Monson, or other emerging curves.
